(19) United States
(12) Patent Application Publication
(10) Pub. No.: US 2024/0052230 A1
(43) Pub. Date: Feb. 15, 2024

(54) WATER-BASED DRILLING FLUIDS COMPRISING SALTS AND NON-REDUCING SUGAR ALCOHOLS

(71) Applicant: UNIQUEM INC., Calgary (CA)

(72) Inventors: Amir A. MIRZAEI, Toronto (CA); Hirbod RAD, Calgary (CA)

(21) Appl. No.: 18/264,738

(22) PCT Filed: Feb. 8, 2021
(86) PCT No.: PCT/CA2021/050140

§ 371 Date: Aug. 8, 2023

(51) Int. Cl. C09K 8/04

(52) U.S. Cl. CPC C09K 8/04

(57) ABSTRACT

Described herein is a water-based drilling fluid comprising a high concentration of one or more soluble salts and a high concentration of one or more non-reducing sugar alcohols. The described drilling fluid has a lower environmental footprint than the conventional brine-based drilling fluids or oil-based drilling muds. A method of using the drilling fluid is also disclosed; the method comprises injecting a water-based drilling fluid comprising a high concentration of one or more soluble salts and a high concentration of one or more non-reducing sugar alcohols into a borehole.

### FIELD

The present invention relates to drilling fluids. More specifically, the present invention is, in aspects, concerned with soluble salts and/or non-reducing sugar alcohols for use in water-based drilling fluids and related compositions and methods.

### BACKGROUND

Approximately one-third to two-thirds the cost of a barrel of oil is spent in drilling. This represents $200 million per day for world production of 60 million barrels per day, at $10/bbl production cost. The time spent drilling hydrocarbon wells in rotating the drill bit at the bottom of the hole (i.e., actually cutting the rock) increases from about 25% for shallow wells to almost 50% as the well depth increases to 15,000 feet, with an overall average of 34%. Of the total footage drilled, 75% is in shales. Drilling through shales is costly and causes over 90% of wellbore stability problems. It also results in a variety of problems from washout to complete collapse of the hole. More typically, drilling problems in shales are bit balling, sloughing, or creep. The problem is severe; it as been estimated to be a $500 million/year problem.

The engineering problems of instability in shales are intricately connected with the bulk properties of shales such as strength and deformation which are a function of depositional environment, porosity, water content, clay content, composition, compaction history, etc. The bulk properties of the drilling fluid such as the chemical makeup and concentration of the continuous phase of the mud, the composition and type of an internal phase if present, the additives associated with the continuous phase, and the maintenance of the system are also of engineering importance. Other factors such as in situ stresses, pore pressure, temperature, time in open hole, depth and length of the open hole interval, surrounding geological environment (salt dome, tectonics, etc.), also directly impact drilling and completion operations. For a successful drilling operation these parameters must be integrated into well planning, mud system selection criteria, and/or new mud development. These variables are interconnected and influence the overall (in)stability in shales while drilling.

As oil reserves deplete and the cost of drilling increases, the need to drill extended-reach wells with long open hole intervals will also increase. In the past, oil-based muds (OBM) have been the workhorse of the industry for difficult drilling. Their application has been typically justified based on borehole stability, fluid loss, filter cake quality, lubricity, and temperature stability. As the environmental concerns restrict the use of oil-based muds, the industry must provide innovative means to obtain OBM performance without negatively impacting the environment. The successful introduction and application of ester-based biodegradable invert emulsion drilling fluids in the past decade have provided attractive alternatives to traditional OBM in accessing hydrocarbon reserves located in environmentally sensitive regions. The costs associated with the use of these biodegradable invert emulsion drilling fluid systems limit the application of such systems on a routine basis. Water-based muds (WBM) are still attractive replacements from a direct cost point-of-view. But, conventional WBM systems have failed to meet key performance criteria obtained with OBM in terms of rate of penetration (ROP), bit and stabilizer balling, lubricity, filtercake quality and thermal stability. More importantly, severe borehole (in)stability problems are encountered when drilling shale formations with conventional WBM, leading to significant increases in the overall well cost.

Over the last decade, technological advancement in finding functional additives to improve the performance of WBMs have led to market domination by these fluids. Brine based drilling fluids where soluble salts are used to increase the density of WBMs while imparting shale inhibition properties found widespread acceptance and proved advantageous over OBM and synthetic based muds as the cost of environmental cleanup and treatment more than compensated the slight technical advantages left for these fluids. Still, there are areas of technical improvement which can further increase the acceptance of WBMs and in turn lower the environmental footprints of the industry. Some of these areas are:

Lubricity: lubricity is arguably one of the most important features of a drilling fluid. Lubricity of a drilling fluid directly affects the rate of penetration or ROP which in turn translates into shorter rig time which is the most expensive component of a typical drilling program.

Shale inhibition: shales are loosely consolidated clays with extremely low permeability and until about two decades ago, were considered expensive blockages and more often than not would cause abandonment of an expensive program. The advent and maturity of shale fracturing to unlock the oil trapped in shale formations changed the industry and its perception of shale. Holes are drilled through shale formations and then the fracturing operation starts in what is referred to as multi-stage fracing. For a multi-stage fracing operation to be successful, a clean, stable hole is of paramount importance and that's what makes the selection of proper drilling fluid more and more important. One major disadvantage of WBMs compared to OBMs is their activity towards shales or the other way around. Unlike oils, water tends to penetrate the internal lattices of loosely consolidated reactive clays and cause their swelling and disintegration with subsequent hole destabilization. Many additives were developed to remediate or permanently address this issue but there is still a need for more cost-effective and environmentally friendly additives.

Corrosion inhibition: another disadvantage of WBMs versus OBMs are their relative corrosiveness specially the brine-based ones which usually contain corrosive brines as the main components of density addition. Increasing the density of drilling fluids is one of the challenges of any mud system. In the past, high density, insoluble solids were the products of choice for increasing the density. Their incorporation required addition of other additives to suspend them and prevent their agglomeration and settling. Pore plugging and formation damage were also appeared as one of their associated problems. Soluble salts addressed most of those problems in the WBMs but created their own and that was their unusual corrosivity. While there has been progress in combating and inhibiting the corrosion problem, the need for more effective inhibition system is felt by the industry insiders.

### SUMMARY

In accordance with an aspect, there is provided a series of drilling fluids with superior performance and lower environmental footprints than the conventional brine-based drilling fluids.

In accordance with an aspect, there is provided a water-based drilling fluid comprising a high concentration of one or more soluble salts and/or a high concentration of one or more non-reducing sugar alcohols.

In an aspect, the soluble salts are present in a concentration of at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90% w/v or w/w of the drilling fluid, such as from about 20 to about 50% w/v or w/w of the drilling fluid.

In an aspect, the soluble salts are fully dissolved or partially dissolved.

In an aspect, the soluble salts have fair to high solubility in water.

In an aspect, the soluble salts have at least 1% solubility in water, preferably at least 5% solubility in water, or more preferably at least 10% solubility in water.

In an aspect, the soluble salts have an acceptable temperature-solubility profile.

In an aspect, the soluble salts comprise silicates, such as lithium, sodium, potassium, and/or cesium silicates, sulphates, formates, acetates, propionates, chlorides, nitrates, sulphamates, or any combinations thereof.

In an aspect, the non-reducing sugar alcohols comprise higher non-reducing sugar alcohols.

In an aspect, the non-reducing sugar alcohols comprise more than three hydroxyl functional groups.

In an aspect, the non-reducing sugar alcohols comprise erythritol, threitol, arabitol, xylitol, ribitol, mannitol, sorbitol, galactitol, fucitol, iditol, inositol, volemitol, isomalt, maltitol, lactitol, maltotriitol, maltotetraitol, polyglycitol, hydrogenated starch hydrolysate, or any combination thereof.

In an aspect, the non-reducing sugar alcohols are present in a concentration of at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90% w/v or w/w of the drilling fluid, such as from about 20 to about 50% w/v or w/w of the drilling fluid, such as from about 1 to about 70% by mass, or about 15 to about 40% by mass.

In an aspect, the drilling fluid comprises from about 10 to about 40% by mass of the non-reducing sugar alcohol.

In an aspect, the drilling fluid comprises from about 15 to about 30% by mass of the non-reducing sugar alcohol.

In an aspect, the drilling fluid comprises both the soluble salt and the non-reducing sugar alcohol.

In an aspect, the drilling fluid comprises water, soluble metal salts, weight agents such as barite and/or hematite, rheology modifiers, such as bentonite and/or xanthan gum, fluid loss and lost circulation materials, such as walnut shell powder, starch, and/or polyanionic cellulose, oxygen scavengers, hydrogen sulfide scavengers, emulsifiers, demulsifiers, scale inhibitors, coagulants, biocides, flocculants, surfactants, shale and clay inhibitors, viscosifiers, lubricants, or combinations thereof.

In an aspect, the drilling fluid further comprises a buffering agent.

In an aspect, the drilling fluid further comprises an alkalinizing agent.

In an aspect, the drilling fluid further comprises finely divided or colloidal filter cake forming solids.

In accordance with an aspect, there is provided a high concentration of a soluble salt and/or a high concentration of a non-reducing sugar alcohol for use in a drilling fluid.

In accordance with an aspect, there is provided a use of a high concentration of a soluble salt and/or a high concentration of a non-reducing sugar alcohol in a drilling fluid.

In accordance with an aspect, there is provided a method of drilling, the method comprising injecting the drilling fluid described herein into a borehole.

Other features and advantages of the present invention will become apparent from the following detailed description. It should be understood, however, that the detailed description and the specific examples while indicating embodiments of the invention are given by way of illustration only, since various changes and modifications within the spirit and scope of the invention will become apparent to those skilled in the art from said detailed description.

### DETAILED DESCRIPTION

### Definitions

In understanding the scope of the present application, the articles “a”, “an”, “the”, and “said” are intended to mean that there are one or more of the elements. Additionally, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

It will be understood that any aspects described as “comprising” certain components may also “consist of” or “consist essentially of,” (or vice versa) wherein “consisting of” has a closed-ended or restrictive meaning and “consisting essentially of” means including the components specified but excluding other components except for materials present as impurities, unavoidable materials present as a result of processes used to provide the components, and components added for a purpose other than achieving the technical effects described herein. For example, a composition defined using the phrase “consisting essentially of” encompasses any known pharmaceutically acceptable additive, excipient, diluent, carrier, and the like. Typically, a composition consisting essentially of a set of components will comprise less than 5% by weight, typically less than 3% by weight, more typically less than 1% by weight of non-specified components.

It will be understood that any component defined herein as being included may be explicitly excluded by way of proviso or negative limitation, such as any specific compounds or method steps, whether implicitly or explicitly defined herein.

In addition, all ranges given herein include the end of the ranges and also any intermediate range points, whether explicitly stated or not.

Finally, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

### Compositions and Methods

Described herein are novel additives for use with water-based drilling fluids which can enhance lubricity, increase shale inhibition, and/or control, reduce, or inhibit the corrosion caused by brine-based drilling fluids without the associated environmental costs and the technical shortcomings of conventional drilling fluids.

In aspects, the components and drilling fluids described herein are environmentally acceptable, economical, and will inhibit corrosion.

Thus, described herein are water-based drilling fluids. In aspects, the drilling fluids comprise one or more soluble salts in a high concentration and in other aspects, the drilling fluids comprise one or more non-reducing sugar alcohols in a high concentration. In yet other aspects, the drilling fluids comprise one or more soluble salts in a high concentration one or more non-reducing sugar alcohols in a high concentration. Regarding the soluble salts and non-reducing sugar alcohols, it will be understood that any and all soluble salts and non-reducing sugar alcohols are encompassed herein. Certain examples are given by way of further explanation but are not limiting. In aspects, the soluble salts and/or non-reducing sugar alcohols are considered environmentally friendly. In additional or alternative aspects, the soluble salts and/or non-reducing sugar alcohols are considered safe. In additional or alternative aspects, the soluble salts and/or non-reducing sugar alcohols are suitable for use in a drilling fluid or drilling operation. In additional or alternative aspects, the soluble salts and/or non-reducing sugar alcohols are biodegradable.

As described herein, the soluble salts are typically present in the water-based drilling fluid in a high concentration. For example, the soluble salts may be present in a concentration of at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90% w/v or w/w of the drilling fluid, such as from about 20 to about 50% w/v or w/w of the drilling fluid.

The soluble salts may be in a concentration or have a solubility resulting in the soluble salts being fully dissolved or partially dissolved in the water-based drilling fluid. Typically, the soluble salts have fair to high solubility in water. For example, the soluble salts in aspects have at least 1% solubility in water, preferably at least 5% solubility in water, or more preferably at least 10% solubility in water. Additionally or alternatively, the soluble salts typically have an acceptable temperature-solubility profile.

While any soluble salt or combinations of soluble salts can be used in the water-based drilling fluids described herein, in exemplary aspects, the soluble salts comprise silicates, such as lithium, sodium, potassium, and/or cesium silicates, sulphates, formates, acetates, propionates, chlorides, nitrates, sulphamates, or any combinations thereof.

Turning now to the non-reducing sugar alcohols, typically these comprise higher non-reducing sugar alcohols, such as non-reducing sugar alcohols comprising more than about three hydroxyl functional groups. For example, glycerol, glycols, polyglycerols, water soluble diols or triols, or any combinations thereof may be used herein.

Exemplary non-reducing sugar alcohols include erythritol, threitol, arabitol, xylitol, ribitol, mannitol, sorbitol, galactitol, fucitol, iditol, inositol, volemitol, isomalt, maltitol, lactitol, maltotriitol, maltotetraitol, polyglycitol, hydrogenated starch hydrolysate, or any combination thereof.

As noted herein, the non-reducing sugar alcohols are typically present in the drilling fluids described herein in a concentration of at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90% w/v or w/w of the drilling fluid, such as from about 20 to about 50% w/v or w/w of the drilling fluid, such as from about 1 to about 70% by mass, such as from about 10 to about 40% by mass, from about 15 to about 30% by mass, or from about 15 to about 40% by mass.

When both a soluble salt and a non-reducing sugar alcohol are used in a water-based drilling fluid together, they may be used in any relative ratio. For example, ratios of soluble salt:non-reducing sugar alcohol of from about 1:100 or about 100:1 are contemplated, such as about 1:100, about 1:50, about 1:25, about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 25:1, about 50:1, or about 100:1.

It will be understood that in certain aspects, the drilling fluid comprises only the soluble salt or only the non-reducing sugar alcohol. In certain alternative aspects, the drilling fluid comprises both the soluble salt and the non-reducing sugar alcohol.

Typically, the soluble salt and non-reducing sugar alcohol is safe and easy to use and can be added to a water-based drilling solution at a drilling site. In this way, the soluble salt and/or non-reducing sugar alcohol can be used as needed and added in desired quantities depending on the drilling needs.

The soluble salt and non-reducing sugar alcohol described herein may be used in any water-based drilling fluid as desired, however, typically, the water-based drilling fluid is a brine-based drilling fluid.

Water-based drilling fluids may contain many different excipients or additional components to assist in obtaining desirable properties. For example, the drilling fluids in aspects comprise water, soluble metal salts, weight agents such as barite and/or hematite, rheology modifiers, such as bentonite and/or xanthan gum, fluid loss and lost circulation materials, such as walnut shell powder, starch, and/or polyanionic cellulose, oxygen scavengers, hydrogen sulfide scavengers, emulsifiers, demulsifiers, scale inhibitors, coagulants, biocides, flocculants, surfactants, shale and clay inhibitors, viscosifiers, lubricants, or combinations of any of these components. The drilling fluid in aspects comprises a finely divided or colloidal filter cake forming solids. In additional or alternative aspects, the drilling fluid comprises a buffering agent and/or an alkalinizing agent.

The drilling fluid typically has a pH that is from about 6 to about 12, such as from about 6.5 to about 11, such as from about 7.5 to about 10.5. In aspects, the pH is from about 6, about 6.5, about 7, about 7.5, about 8, about 8.5, about 9, about 9.5, about 10, about 10.5, about 11, or about 11.5 to about 6.5, about 7, about 7.5, about 8, about 8.5, about 9, about 9.5, about 10, about 10.5, about 11, about 11.5, or about 12. The pH is typically adjusted to a desirable level through inclusion of a basic material in the aqueous brine solution.

The drilling fluid can be used at any temperature. Typically, however, the drilling fluid is used a temperature of less than about 200 C. For example, less than about 120 C or less than 70 C. In aspects, the temperature is less than about 200 C, less than about 175 C, less than about 150 C, less than about 125 C, less than about 100 C, less than about 90 C, less than about 80 C, less than about 70 C, less than about 60 C, less than about 50 C, or less than about 40 C.

In additional aspects, a method for drilling, such as for drilling a borehole, is described herein. The method comprises drilling a borehole and injecting the drilling fluid described herein into the borehole.

The above disclosure generally describes the present invention. A more complete understanding can be obtained by reference to the following specific Examples. These Examples are described solely for purposes of illustration and are not intended to limit the scope of the invention. Changes in form and substitution of equivalents are contemplated as circumstances may suggest or render expedient. Although specific terms have been employed herein, such terms are intended in a descriptive sense and not for purposes of limitation.

### EXAMPLES

### Example 1

A drilling fluid was made by adding 30% by weight of calcium chloride and 20% by weight of maltitol. Rheological properties were measured as follows:

| | | | Lubricity | | |
|---|---|---|---|---|---|
| | 35% | CaCl2 + | (Min) at | 35% | CaCl2 + |
| | CaCl2 | Maltitol | 150 psi | CaCl2 | Maltitol |
| 600 | 8 | 8.9 | 0.00 | 14.4 | 3.2 |
| 300 | 4.1 | 4.5 | 0.50 | 14.9 | 3.3 |
| 200 | 2.9 | 3.5 | 1.00 | 15.1 | 3.3 |
| 100 | 1.5 | 1.7 | 1.50 | 15.2 | 3.3 |
| 6 | 0.1 | 0.1 | 2.00 | 15.3 | 3.3 |
| 3 | 0.1 | 0.1 | 2.50 | 15.4 | 3.4 |
| PV | 3.9 | 4.4 | 3.00 | 15.5 | 3.3 |
| YP | 0.1 | 0.1 | 3.50 | 15.3 | 3.4 |
| Density | 1350 | 1350 | 4.00 | 15.3 | 3.4 |
| | | | 4.50 | 15.2 | 3.3 |
| | | | 5.00 | 15.1 | 3.3 |

### Example 2

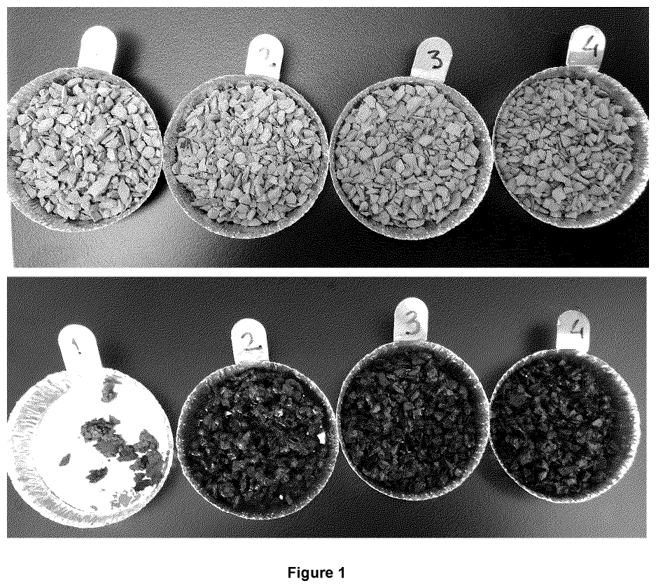

Shale inhibition: Pierre shale chips of comparable sizes were selected, weighed, and added to two fluids from example one and one made with 30% calcium chloride and one with tap water only as a reference. The mixtures were hot rolled for 8 hours at 60 C after which they were left overnight to cool down, screen separated, dried, and weighed again. Images of the shale are in FIG. 1. The difference in weight is indicative of the hydration induced disintegration from which a recovery ratio is calculated, as shown in the table below:

| | | Mass (g) | | | | |
|---|---|---|---|---|---|---|
| | | Shale | | Shale & boat | Shale | Recovery |
| | Fluid | initial | Boat | final | final | (%) |
| 1 | Tap Water | 19.96 | 1.06 | 2.01 | 0.95 | 4.75 |
| 2 | CaCl2 (30%) | 20.02 | 1.05 | 18.03 | 16.98 | 84.82 |
| 3 | CaCl2 + Maltitol | 19.97 | 1.08 | 21.01 | 19.93 | 99.80 |
| 4 | CaCl2 + Maltitol | 20.04 | 1.05 | 21.02 | 19.97 | 99.65 |

### Example 3

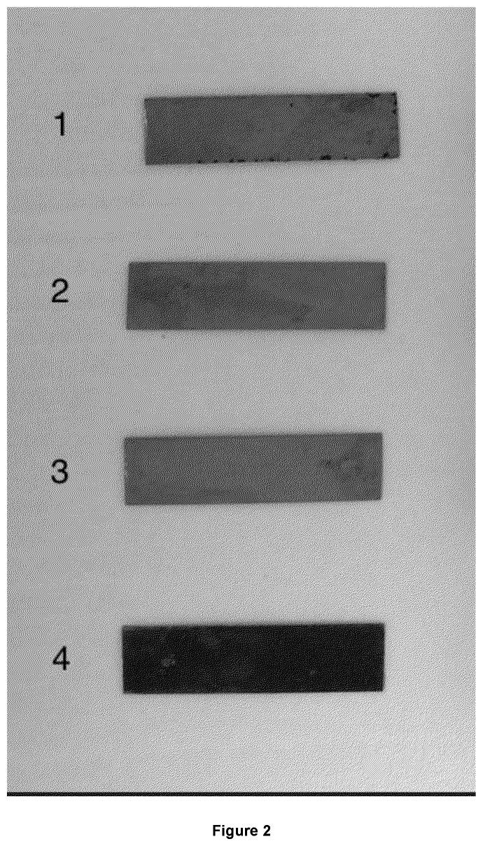

A test was set up to specifically evaluate the corrosivity of the above formulations. To measure the corrosivity of the above fluids and compare them with the conventional brine-based drilling fluids, samples of 2 fluids of the same category but with different salts, one salt being calcium chloride and the other one being sodium chloride both at 30% w/w, were made and the same amount of 15% w/w maltitol was added to each. Another fluid with calcium chloride at 30% w/w was made and divided into two portions. One portion was used as blank and 1% commercial corrosion inhibitor was added to anther one distinguished as CaCl2) inhibited brine. Coupons were weighed and placed in the fluids. The cylinders were sealed and rotated for 72 hours at 60 C after which they were cooled, and the coupons were weighed again and observed for pitting, as shown in FIG. 2 and the table below.

| | Initial | Final | Weight | |
|---|---|---|---|---|
| | weight | weight | loss | Visual |
| | (grams) | (grams) | (grams) | Pitting Marks |
| CaCl2 inhibited brine | 5.725 | 5.689 | 0.036 | Some-mainly |
| | | | | edges |
| CaCl2 + Maltitol | 5.437 | 5.433 | 0.004 | None |
| NaCl + Maltitol | 5.546 | 5.543 | 0.003 | None |
| CaCl2 brine solution | 5.672 | 5.103 | 0.569 | Severe |

The above disclosure generally describes the present invention. Although specific terms have been employed herein, such terms are intended in a descriptive sense and not for purposes of limitation.

All publications, patents and patent applications cited above are herein incorporated by reference in their entirety to the same extent as if each individual publication, patent or patent application was specifically and individually indicated to be incorporated by reference in its entirety.

Although preferred embodiments of the invention have been described herein in detail, it will be understood by those skilled in the art that variations may be made thereto without departing from the spirit of the invention or the scope of the appended claims.

1. A water-based drilling fluid comprising a high concentration of one or more soluble salts and/or a high concentration of one or more non-reducing sugar alcohols.

2. The drilling fluid of claim 1, wherein the soluble salts are present in a concentration of at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90% w/v or w/w of the drilling fluid, such as from about 20 to about 50% w/v or w/w of the drilling fluid.

3. The drilling fluid of claim 1 or 2, wherein the soluble salts are fully dissolved or partially dissolved.

4. The drilling fluid of any one of claims 1 to 3, wherein the soluble salts have fair to high solubility in water.

5. The drilling fluid of claim 4, wherein the soluble salts have at least 1% solubility in water, preferably at least 5% solubility in water, or more preferably at least 10% solubility in water.

6. The drilling fluid of any one of claims 1 to 5, wherein the soluble salts have an acceptable temperature-solubility profile.

7. The drilling fluid of any one of claims 1 to 6, wherein the soluble salts comprise silicates, such as lithium, sodium, potassium, and/or cesium silicates, sulphates, formates, acetates, propionates, chlorides, nitrates, sulphamates, or any combinations thereof.

8. The drilling fluid of any one of claims 1 to 7, wherein the non-reducing sugar alcohols comprise higher non-reducing sugar alcohols.

9. The drilling fluid of claim 8, wherein the non-reducing sugar alcohols comprise more than three hydroxyl functional groups.

10. The drilling fluid of any one of claims 1 to 9, wherein the non-reducing sugar alcohols comprise erythritol, threitol, arabitol, xylitol, ribitol, mannitol, sorbitol, galactitol, fucitol, iditol, inositol, volemitol, isomalt, maltitol, lactitol, maltotriitol, maltotetraitol, polyglycitol, hydrogenated starch hydrolysate, or any combination thereof.

11. The drilling fluid of any one of claims 1 to 10, wherein the non-reducing sugar alcohols are present in a concentration of at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90% w/v or w/w of the drilling fluid, such as from about 20 to about 50% w/v or w/w of the drilling fluid, such as from about 1 to about 70% by mass, or from about 15 to about 40% by mass.

12. The drilling fluid of claim 11, comprising from about 10 to about 40% by mass of the non-reducing sugar alcohol.

13. The drilling fluid of claim 12, comprising from about 15 to about 30% by mass of the non-reducing sugar alcohol.

14. The drilling fluid of any one of claims 1 to 13, comprising both the soluble salt and the non-reducing sugar alcohol.

15. The drilling fluid of any one of claims 1 to 14, comprising water, soluble metal salts, weight agents such as barite and/or hematite, rheology modifiers, such as bentonite and/or xanthan gum, fluid loss and lost circulation materials, such as walnut shell powder, starch, and/or polyanionic cellulose, oxygen scavengers, hydrogen sulfide scavengers, emulsifiers, demulsifiers, scale inhibitors, coagulants, biocides, flocculants, surfactants, shale and clay inhibitors, viscosifiers, lubricants, or combinations thereof.

16. The drilling fluid of any one of claims 1 to 15, further comprising a buffering agent.

17. The drilling fluid of any one of claims 1 to 16, further comprising an alkalinizing agent.

18. The drilling fluid of any one of claims 1 to 17, further comprising finely divided or colloidal filter cake forming solids.

19. A high concentration of a soluble salt and/or a high concentration of a non-reducing sugar alcohol for use in a drilling fluid.

20. Use of a high concentration of a soluble salt and/or a high concentration of a non-reducing sugar alcohol in a drilling fluid.

21. A method of drilling, the method comprising injecting the drilling fluid of any one of claims 1 to 18 into a borehole.
